(19) United States
(12) Patent Application Publication
(10) Pub. No.: US 2025/0346298 A1
(43) Pub. Date: Nov. 13, 2025

(54) VEHICLE HOOD ASSEMBLY HAVING A WATERFALL REGION SUPPORTING A LATCH REINFORCEMENT

(71) Applicant: Ford Global Technologies, LLC, Dearborn, MI (US)

(72) Inventors: Benjamin Marrufo Rogel, Mexico City (MX); Olena Danae Cruz Jimenez, Metepec (MX); Jacob Urias Lopez Munive, Tlalnepantla (MX); Mark Joseph Courtright, Allen Park, MI (US); Omar Valdez, Cuautitlan Izcalli (MX)

(21) Appl. No.: 18/661,988

(22) Filed: May 13, 2024

(51) Int. Cl. B62D 25/10; B62D 25/12

(52) U.S. Cl. CPC B62D 25/105; B62D 25/12

(57) ABSTRACT

A vehicle hood assembly, including: a hood outer; a hood inner having a domed region and a waterfall region; and a latch reinforcement that is secured to the waterfall region. A vehicle closure module latch supporting method includes providing a waterfall region of a hood inner extending directly from a domed region of the hood inner and securing a latch reinforcement of a latch assembly to the waterfall region. The vehicle hood assembly can omit a palm dimpler.

### TECHNICAL FIELD

This disclosure relates generally to a hood assembly for a vehicle and, more particularly, to a hood assembly having a hood inner with a waterfall region that supports a latch reinforcement.

### BACKGROUND

Vehicles include various closure members (e.g., side doors, liftgates, hoods, trunk lids, etc.). The closure members are pivotably coupled to a vehicle body, and are configured to pivot back-and-forth between a closed position and an open position relative to the vehicle body. A hood assembly is a type of vehicle closure member that can cover an area at a front of the vehicle when in a closed position. The hood assembly can cover, for example, a frunk or an engine compartment.

### SUMMARY

In some aspects, the techniques described herein relate to a vehicle hood assembly, including: a hood outer; a hood inner having a domed region and a waterfall region; and a latch reinforcement that is secured to the waterfall region.

In some aspects, the techniques described herein relate to a vehicle hood assembly, wherein the hood outer and the hood inner are constituents of a hood assembly that is configured to pivot together relative to a vehicle frame back-and-forth between a closed position and an open position.

In some aspects, the techniques described herein relate to a vehicle hood assembly, wherein the hood assembly encloses a frunk of an electrified vehicle when in the closed position.

In some aspects, the techniques described herein relate to a vehicle hood assembly, wherein the waterfall region cascades downward from the domed region when the hood assembly is in the closed position.

In some aspects, the techniques described herein relate to a vehicle hood assembly, wherein the waterfall region cascades downward to a position adjacent a bumper assembly when the hood assembly is in the closed position.

In some aspects, the techniques described herein relate to a vehicle hood assembly, wherein the waterfall region cascades downward to a position between a driver side headlight assembly and a passenger side headlight assembly when the hood assembly is in the closed position.

In some aspects, the techniques described herein relate to a vehicle hood assembly, wherein the hood assembly lacks a palm dimpler disposed between the domed region and the waterfall region.

In some aspects, the techniques described herein relate to a vehicle hood assembly, wherein the latch reinforcement is a constituent element of a hood latch assembly.

In some aspects, the techniques described herein relate to a vehicle hood assembly, wherein the latch reinforcement is a striker reinforcement.

In some aspects, the techniques described herein relate to a vehicle hood assembly, wherein the domed region transitions directly into the waterfall region.

In some aspects, the techniques described herein relate to a vehicle hood assembly, wherein the domed region includes a plurality of apertures.

In some aspects, the techniques described herein relate to a vehicle hood assembly, wherein an area between the domed region and the waterfall region is unchanneled.

In some aspects, the techniques described herein relate to a vehicle hood assembly, further including a passenger side hinge reinforcement and a driver side hinge reinforcement disposed on opposing sides of the domed region.

In some aspects, the techniques described herein relate to a vehicle hood assembly, wherein the domed region is adhesively secured to the hood outer at a position aft the waterfall region.

In some aspects, the techniques described herein relate to a vehicle closure module latch supporting method, including: providing a waterfall region of a hood inner extending directly from a domed region of the hood inner; and securing a latch reinforcement of a latch assembly to the waterfall region.

In some aspects, the techniques described herein relate to a method, further including providing the waterfall region without a channel between the waterfall region and the domed region.

In some aspects, the techniques described herein relate to a method, further including securing the hood inner to a hood outer without including a palm dimpler between the hood inner and the hood outer.

In some aspects, the techniques described herein relate to a method, wherein the waterfall region cascades downward to a position between a driver side headlight assembly and a passenger side headlight assembly when in a closed position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle having a hood assembly in an open position according to an exemplary embodiment of the present disclosure.

FIG. 2 shows the vehicle of FIG. 1 with the hood assembly in a closed position.

FIG. 3 shows a perspective view of the hood inner from the hood assembly of FIGS. 1 and 2.

FIG. 4 illustrates a top view of the hood inner of FIG. 3.

FIG. 5 illustrates a section view through the hood assembly at section 5-5 in FIG. 2.

FIG. 6 illustrates a section view of the hood assembly taken at line 6-6 in FIG. 2.

### DETAILED DESCRIPTION

This disclosure details hood assemblies that can be used to enclose a frunk or an engine compartment, for example. The hood assemblies extend a waterfall region directly from a domed region without any channel therebetween. The hood assemblies of the example of this disclosure also do not incorporate a palm dimpler bracket in front of a domed region, which is a characteristic of prior art hood assemblies.

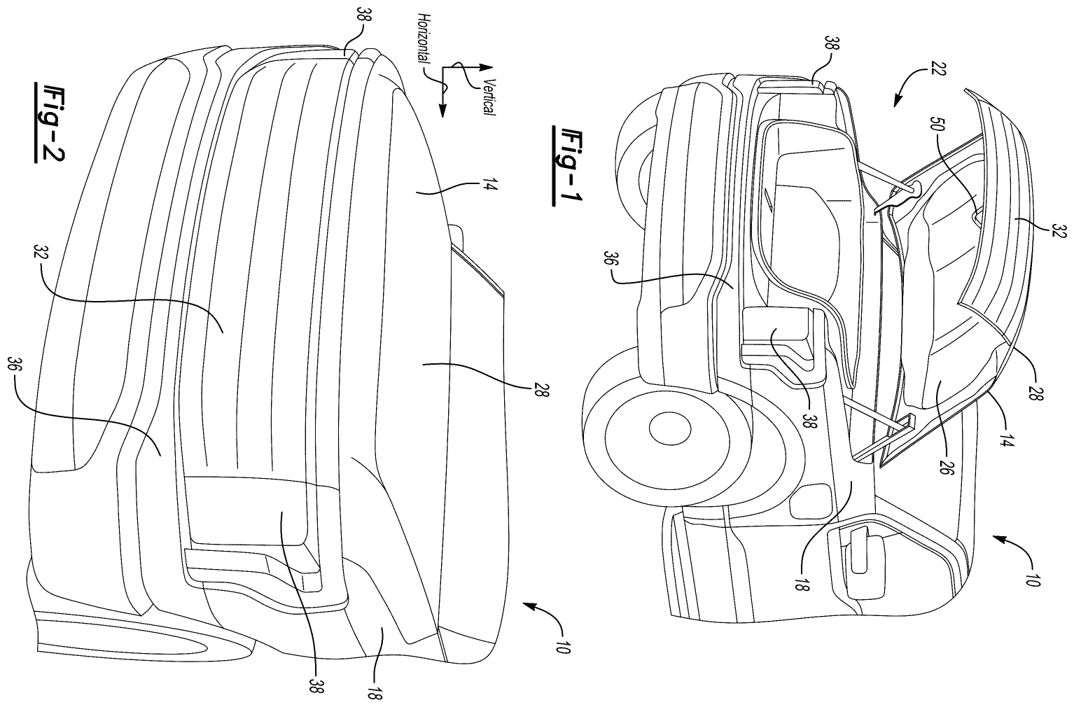

With reference to FIGS. 1 and 2, a vehicle includes a hood assembly 14 pivotably secured to a vehicle frame 18. When the hood assembly 14 is in the open position of FIG. 1, a user can access a frunk 22 of the vehicle 10. The hood assembly 14 can moved to the closed position of FIG. 2 to enclosure the frunk 22. The hood assembly 14 is used in connection with the frunk 22, but could be used in other examples in connection with a conventional vehicle having an engine compartment.

The vehicle 10 is an electrified vehicle and, more specifically, an all-electric vehicle that does not rely on an internal combustion engine for propulsion. Thus, the vehicle 10 includes no engine and no engine compartment. The space typically reserved for the engine can be utilized as the frunk 22 in the vehicle 10.

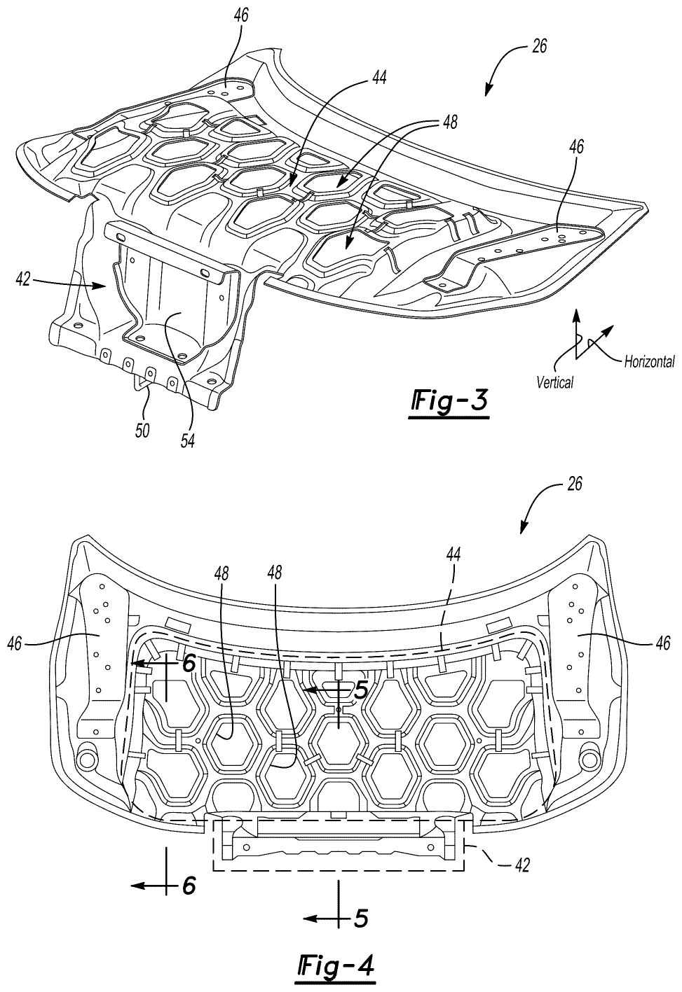

With reference now to FIGS. 3 and 4 and continuing reference to FIGS. 1 and 2, the hood assembly 14 includes a hood inner 26 and a hood outer 28. The hood outer 28 is visible when the hood assembly 14 is in the closed position of FIG. 2. The hood outer 28 supports a grille 32 of the vehicle 10. The grille 32 can be functional and include apertures that permit airflow. The grille 32 could instead be an aesthetic grille lacking such apertures. In other examples, the grille 32 is omitted and the hood outer 28 supports another feature (e.g., a decorative panel).

The grille 32 is vertically directly above a bumper 36 of the vehicle 10 and horizontally between headlights 38 of the vehicle 10. Vertical and horizontal, for purposes of this disclosure, are with reference to ground in a general orientation of the vehicle 10 during typical operation.

The hood inner 26 includes, in this example, a waterfall region 42, a domed region 44, and a pair of hinge reinforcements 46. The waterfall region 42 cascades downward from the domed region 44 when the hood assembly 14 is in the closed position.

The domed region 44 is a raised region of the hood inner 26. The example domed region includes a plurality of apertures 48.

The domed region 44 transitions directly into the waterfall region 42 of the hood inner 26 without any intervening structure. In the past, components such a palm dimplers have been used in areas in front of domed regions of hood inners to strengthen the hood assembly. The example hood assembly 14 transitions directly from the domed region 44 into the waterfall region 42 without any intervening palm dimpler. The domed region 44 can be considered a “power” dome in some examples.

Extending the waterfall region 42 directly from the domed region 44 also occurs without incorporating any intervening channel formation within the hood inner 26. Any area between the waterfall region 42 and the domed region 44 can thus be considered unchanneled.

This direct transition-without a channel or palm dimpler-can facilitate an increased volume of the frunk 22. In this example, a total volume of the frunk 22 is at least three liters greater than a hood inner used with a palm dimpler.

A latch assembly 50 is used to hold the example hood assembly 14 in the closed position of FIG. 2. The latch assembly 50 includes a reinforcement member, here a striker reinforcement 54 that is secured to the waterfall region 42. The waterfall region 42 and the striker reinforcement 54 face forward from the vehicle 10.

The striker reinforcement 54 could be secured utilizing rivets, welds, or some other attachment mechanism. When the hood assembly 14 is in the closed position, the waterfall region 42 is disposed horizontally between the headlights 38 and directly above the bumper 36. The striker reinforcement 54 is also disposed between the headlights 38.

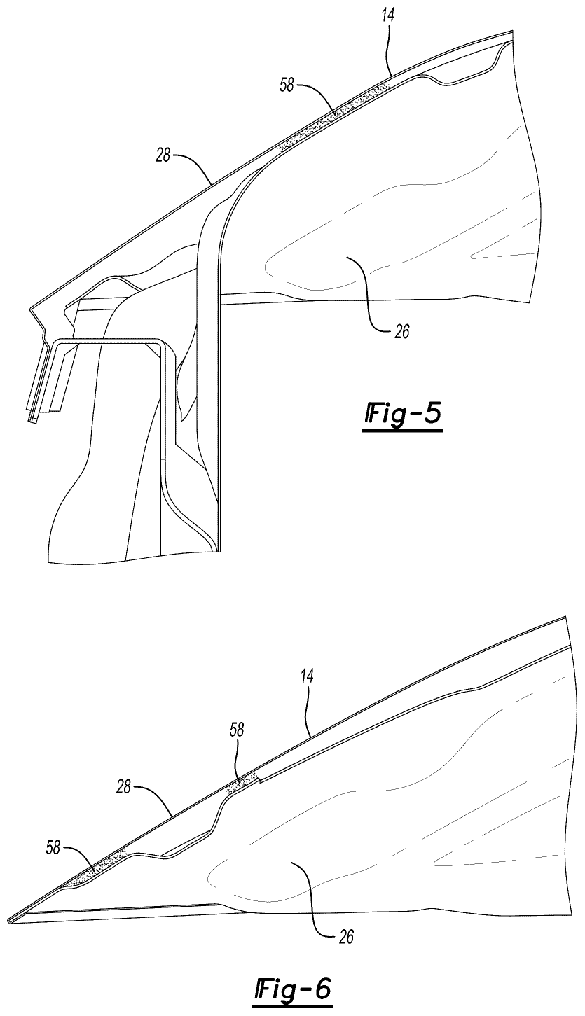

Referring to the section view of FIGS. 5 and 6 and with continuing reference to FIGS. 3 and 4, the hood inner 26 is secured to the hood outer 28 about at least part of a perimeter of the hood assembly 14 using a hemmed joint. In an example, the securing strategy additionally includes an adhesive bond 58 securing the domed region 44 of the hood inner 26 directly to the hood outer 28. A mastic adhesive provides the adhesive bonds in some examples.

Features of the disclosed examples include a hood inner that meets loading goals without the use of a palm dimpler or channel between a domed region and a waterfall region. This can, among other things, facilitate reducing part complexity without permitting dimpling.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle hood assembly, comprising:
a hood outer;
a hood inner having a domed region and a waterfall region; and
a latch reinforcement that is secured to the waterfall region.

2. The vehicle hood assembly of claim 1, wherein the hood outer and the hood inner are constituents of a hood assembly that is configured to pivot together relative to a vehicle frame back-and-forth between a closed position and an open position.

3. The vehicle hood assembly of claim 2, wherein the hood assembly encloses a frunk of an electrified vehicle when in the closed position.

4. The vehicle hood assembly of claim 2, wherein the waterfall region cascades downward from the domed region when the hood assembly is in the closed position.

5. The vehicle hood assembly of claim 4, wherein the waterfall region cascades downward to a position adjacent a bumper assembly when the hood assembly is in the closed position.

6. The vehicle hood assembly of claim 5, wherein the waterfall region cascades downward to a position between a driver side headlight assembly and a passenger side headlight assembly when the hood assembly is in the closed position.

7. The vehicle hood assembly of claim 2, wherein the hood assembly lacks a palm dimpler disposed between the domed region and the waterfall region.

8. The vehicle hood assembly of claim 1, wherein the latch reinforcement is a constituent element of a hood latch assembly.

9. The vehicle hood assembly of claim 1, wherein the latch reinforcement is a striker reinforcement.

10. The vehicle hood assembly of claim 1, wherein the domed region transitions directly into the waterfall region.

11. The vehicle hood assembly of claim 1, wherein the domed region includes a plurality of apertures.

12. The vehicle hood assembly of claim 1, wherein an area between the domed region and the waterfall region is unchanneled.

13. The vehicle hood assembly of claim 1, further comprising a passenger side hinge reinforcement and a driver side hinge reinforcement disposed on opposing sides of the domed region.

14. The vehicle hood assembly of claim 1, wherein the domed region is adhesively secured to the hood outer at a position aft the waterfall region.

15. A vehicle closure module latch supporting method, comprising:
providing a waterfall region of a hood inner extending directly from a domed region of the hood inner; and
securing a latch reinforcement of a latch assembly to the waterfall region.

16. The method of claim 15, further comprising providing the waterfall region without a channel between the waterfall region and the domed region.

17. The method of claim 15, further comprising securing the hood inner to a hood outer without including a palm dimpler between the hood inner and the hood outer.

18. The method of claim 15, wherein the waterfall region cascades downward to a position between a driver side headlight assembly and a passenger side headlight assembly when in a closed position.
